(19) United States
(12) Patent Application Publication
(10) Pub. No.: US 2014/0019486 A1
(43) Pub. Date: Jan. 16, 2014

(54) Logic Content Processing for Hardware Acceleration of Multi-Pattern Search

(71) Applicant: Amitava Majumdar, San Jose, CA (US)

(72) Inventor: Amitava Majumdar, San Jose, CA (US)

(21) Appl. No.: 13/922,220

(22) Filed: Jun. 19, 2013

Related U.S. Application Data
(60) Provisional application No. 61/671,650, filed on Jul. 13, 2012.

(51) Int. Cl. G06F 17/30

(52) U.S. Cl. CPC G06F 17/30424
USPC 707/780

(57) ABSTRACT

The embodiments herein relate to multi pattern searching and, more particularly, to multi pattern search or multi pattern matching using logic content processing. The input pattern is type cast to a Boolean alphabet and is then processed to create a corresponding signature set. Further, the signature set is divided into subsets and a Boolean logic function representing each signature subset is created. Further, the values of each subset are simultaneously compared with windows of an input data steam or data file to find a match. If a match is found, the system returns a hit, else a miss. Parallel stages may be added to enhance performance of the system, as multiple inputs may be processed at a time.

### PRIORITY DETAILS

The present application is based on, and claims priority from, U.S. Application No. 61/671,650, filed on 13 Jul. 2012, the disclosure of which is hereby incorporated by reference herein.

### TECHNICAL FIELD

The embodiments herein relate to multi pattern searching or multi pattern matching and, more particularly, to multi pattern searching or matching using logic content processing.

### BACKGROUND

Multi-pattern search (MPS), also known as multi pattern matching, involves searching for signatures from a large signature database inside one or more data items. Multi-pattern search finds application in fields such as dictionary search, as a defense mechanism against intrusions such as worms, viruses etc, intrusion detection, data analysis, data mining, DNA sequencing and so on. Many types of MPS have been introduced, which have applications based on system requirements.

State machine based MPS may be used to search for fixed length strings and variable length strings. An example for state machine based MPS uses Aho-Corasick algorithm to match strings. One disadvantage of the state machine based MPS is that it imposes high demands on memory and memory bandwidth. Higher memory usage may slow down the entire system. Further, the high memory requirement may affect hardware realization of the system. Further, for increase in number of patterns/signatures, memory requirement may increase in terms of mega bytes, which demands more power, which in turn affects overall system performance. Further, a DRAM may be required even for storing a small number of signatures. Another disadvantage of the state machine based MPS is the latency involved in the process. At higher rates, data are sampled for analysis. In the process of sampling and analysis, many packets that are not part of the sample may go into the system undetected, which increases latency of patterns in the system.

Hash based MPS use hash values for pattern searching. An example is Rabin-Karp algorithm. Randomized representation (or hash) of each string is expressed as fixed length sequences of bits and used as a fingerprint of a string. In order to make this process efficient, Rabin-Karp method uses a “rolling” hash function where the hash for a new n-gram; which is a special signature of a specific pattern, is computed from that of the old one by “subtracting” the value of the last character of the old string (the one that will be removed in the next window) and adding an appropriate hash difference for the new incoming character. So as to identify which signature caused the hit in case of a match, data structures are created and used. Further, memory requirements depend on length of signature. A disadvantage of the hash based MPS system is high probability of false positives. In a hash based system, hash values are spread evenly in signature space. This increases probability of false positive as a linear function of number of patterns i.e. number of false positives increases with number of patterns, which in turn affects performance of the algorithm. The number of false positives may be reduced by using multiple hash functions at a time. But, this increases system size, power and system overhead. Another disadvantage of the hash based systems is that it randomizes signatures, resulting in less control over the signatures.

Content Addressable Memory (CAM) based MPS engines are available for processing fixed length patterns. In this process, each pattern has a unique signature and a separate comparator may be used to process each pattern. One disadvantage of the CAM based systems is that their power requirement is very high. Further, with increase in number of signatures, size and power requirement of the CAM based system increases even further, which reduces its scalability.

### BRIEF DESCRIPTION OF THE FIGURES

The embodiments herein will be better understood from the following detailed description with reference to the drawings, in which:

FIGS. 1A and 1B illustrate block diagrams of the logic content based multi pattern search system and a pipeline based architecture of the multi pattern search system respectively, as disclosed in the embodiments herein;

FIGS. 2A, 2B and 2C illustrate an example of Truth Table (TT) based implementation of the logic function, as disclosed in the embodiments herein;

FIGS. 3A and 3B illustrate pattern set scaling and data rate scaling respectively, as disclosed in the embodiments herein;

FIG. 4 illustrates a flow diagram that shows various steps involved in the process of generating a logic content based multi pattern search module, as disclosed in the embodiments herein; and

FIG. 5 illustrates a flow diagram that shows various steps involved in the process of implementing logic function for each thread during the generation of logic content based multi pattern search module, as disclosed in the embodiments herein.

### DEFINITIONS

Terms Logic Content Processing and LCP are used interchangeably.

Similarly Multi-Pattern Search, MPS, Multi-Pattern Matching and MPM are used interchangeably.

String:—String is a concatenation of objects. Permutations of distinct objects in a string form distinct strings.

Sub-string:—A sub-string of a string is the usual interpretation.

Length of a string:—Length of a string, denoted as L(s), is the number of objects in the string.

Alphabet (A):—An alphabet associated with a string, is a set of objects from which elements in the string are chosen. Common examples of alphabet are the set of characters (to create strings of characters), the set of integers (to create strings of integers) and the set of digits to express integers as strings of digits.

Pattern:—A pattern (or input data pattern) is a special string of interest that we search for in other strings. For example, a worm's binary code is a string of characters, which we call a pattern because we are interested in searching for this special string inside other strings that are found as part of internet traffic. We define this term only to distinguish between strings of special interest to us and those that are not.

Pattern set:—A pattern set (or the input pattern set) is a collection of zero or more patterns. If the pattern set contains zero patterns it is called a null pattern set.

Signature:—A signature associated with a pattern is a representation of or a proxy for the pattern. A signature is usually a sub-string of a pattern but can be a different representation, possibly a pattern in a different alphabet. Zero, one or more than one signatures may be associated with a single pattern.

Signature set:—A signature set is a collection of zero or more distinct signatures, each signature associated with exactly one pattern from the pattern set. If a signature contains zero signatures then it is called a null signature set.

n-gram:—n-gram associated with a pattern is a special signature of the pattern that is a substring (of the pattern) of length n.

Stream [file]: A stream [file] is a string in which we search for patterns. It is implied that a stream [file] is a concatenation of objects from the same alphabet used to define the patterns. Streams are considered dynamic from/to a communication link whereas files are static strings in memory.

Bit or Boolean value:—A bit takes a value 0 (called “zero”), 1 (called “one”) or X. The value X is called a “don't care”.

Bit Vector or Boolean Vector:—An ordered string or collection of bits is called a bit vector or Boolean vector.

Length of a bit-vector:—The length of a bit-vector is the number of bits in the vector. A bit-vector of length n is also called an n-gram of bits (defined above).

Equality of bit vectors: Two bit vectors are considered equal if both vectors have the same length and for each bit, the value of that bit of one or both of the vectors is X (i.e. a don't care) or values of that bit for both vectors are same. Otherwise the two bit vectors are unequal or different.

n-Window:—A n-window is an n-bit sub-string or n-bit vector of a stream [file] of length n. As the name suggests, a window of a stream [file] is not a constant sub-string of the stream [file]. It can be any consecutive bits of length n from within the stream [file]. n is called the length of the window.

Content or value of a window:—Content or value of a window is the bit vector in that window. As described above, the content of an n-bit window changes over time.

Throughput:—Throughput of pattern matching is the number of objects in a string (such as an input stream or file) that are searched for signatures per unit of time.

Hit or match:—A window is said to have a hit or match if its content equals one or more signatures from the signature set. Otherwise it is a miss or mis-match.

Latency:—Latency of a pattern is the amount of time it is resident in a system's storage, either as part of a file or as a part of a data-stream stored in the system, before its presence is detected.

Thread:—A thread is a collection of LCP functions corresponding to a signature set (or a pattern set) that searches for signatures from the set in a data-stream or file to produce a single hit-miss result, possibly by consolidating multiple hit/miss results from individual LCP functions.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

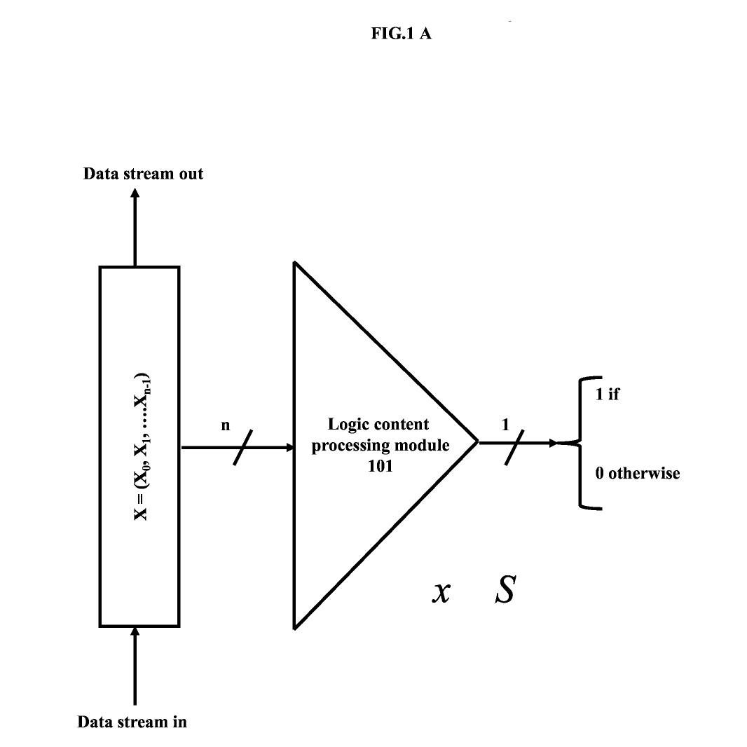

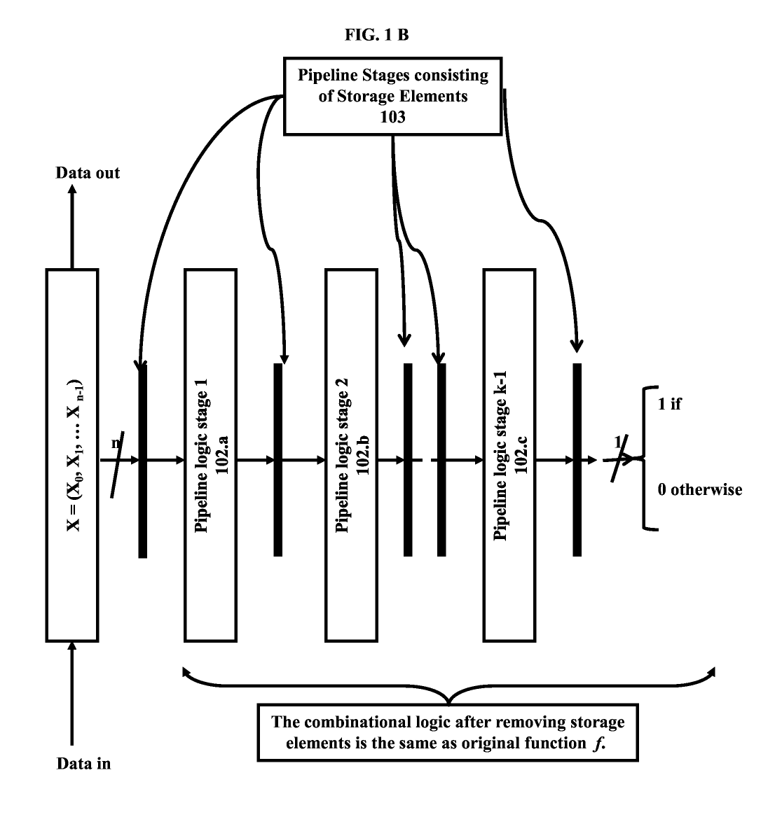

The embodiments herein disclose a process of improving efficiency of multi pattern search by implementing a logic content processing based multi-patter search module. Referring now to the drawings, and more particularly to FIGS. 1 through 5, where similar reference characters denote corresponding features consistently throughout the figures, there are shown embodiments.

FIGS. 1A and 1B illustrate block diagrams of the logic content based multi pattern search system and a pipeline based architecture of the multi pattern search system respectively, as disclosed in the embodiments herein. The multi pattern search process has two stages. In the initial stage, the system searches for patterns and signatures in a stream or file using a specific search method which is capable of processing inputs at high speeds. In this process, so as to improve speed, the system searches only for sub-patterns instead of the full patterns, which results in less accuracy, as all variable length patterns are not considered. In the second stage, a post processing is done to ensure that a “hit” produced in first stage is due to the presence of an actual pattern and hence is a “true positive” hit. Note that if there is a hit for a signature in the first stage, but a post-processing step determines that the string does not contain the corresponding pattern, it is considered a “false positive”. Post processing is a time consuming process which reduces efficiency and adds to latency of the system. Further, the latency increases with increase in number of false positives in the system. Logic content based multi pattern search reduces latency and increases efficiency of the system by reducing number of false positives.

The logic content based multi pattern search system comprises a logic content processing module 101. Input to the logic content processing module 101 is a string of data that comprises objects from an alphabet. The input has to be converted to a machine readable format so as to process further. This is preferably achieved using a Boolean casting process.

The Boolean cast data can be then processed using the logic content processing logic present in the logic content processing module 101. The logic content processing module 101 compares Boolean vectors corresponding to the signature sets and sub-sets of the input data patterns with windows or consecutive n-bit subsets of a stream or file such that each window has the same length n as the signatures. During this process, the system checks whether the value of one (or more) of the signatures in the signature set matches with value of any of the windows of the stream (or file). If a match is found, i.e. value of a signature in the signature set is found to be equal to value of a window, then the system returns a “hit” which means the signature matches with one or more of windows. If no match is found, it is considered a “miss”.

In an embodiment, pipeline stages may be added to enhance performance of the system. The pipeline stage may comprise logic blocks 102 and storage blocks 103 arranged in series such that output of one block is input to next block. Output of the pipeline architecture is a one bit signal which indicates either a “hit” or a “miss”.

When the system receives indication of a “hit”, it verifies the result off-line, as part of a post-processing step, to ensure that the part of the stream or file containing the signature that caused the hit is a pattern of interest, thereby eliminating/reducing the possibility of false positives. Further, in MPS, pattern sets and their corresponding signature sets change over time and accordingly, the logic functions to detect them, need to be changed as well. This can be achieved by implementing the logic function using suitable programmable logic. Further, a database of empirical data may also be maintained that may be used as a reference while calculating parameters such as maximum number of signatures, number of inputs bits and so on.

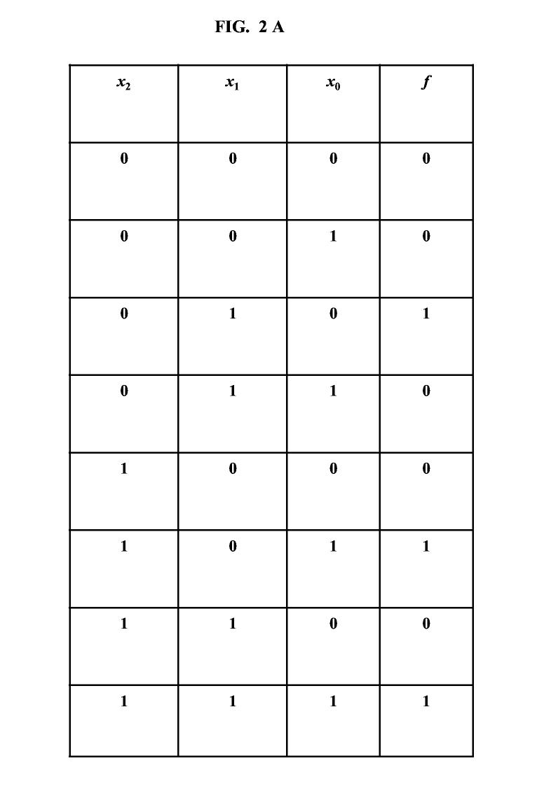

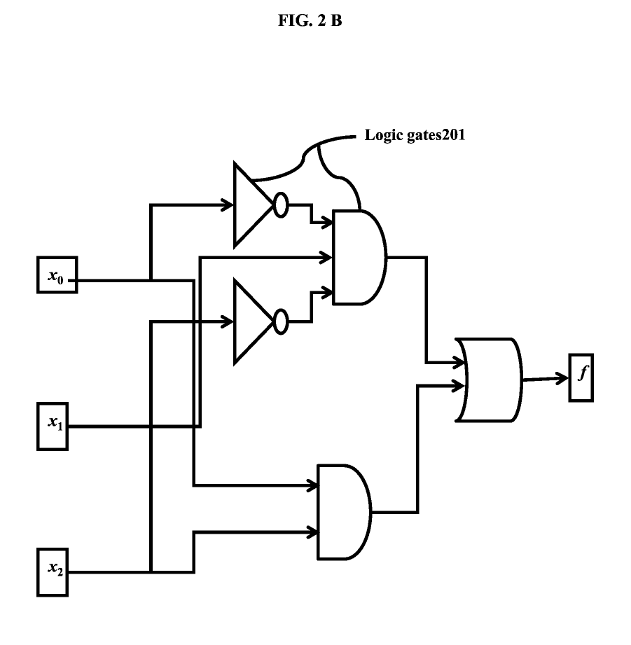

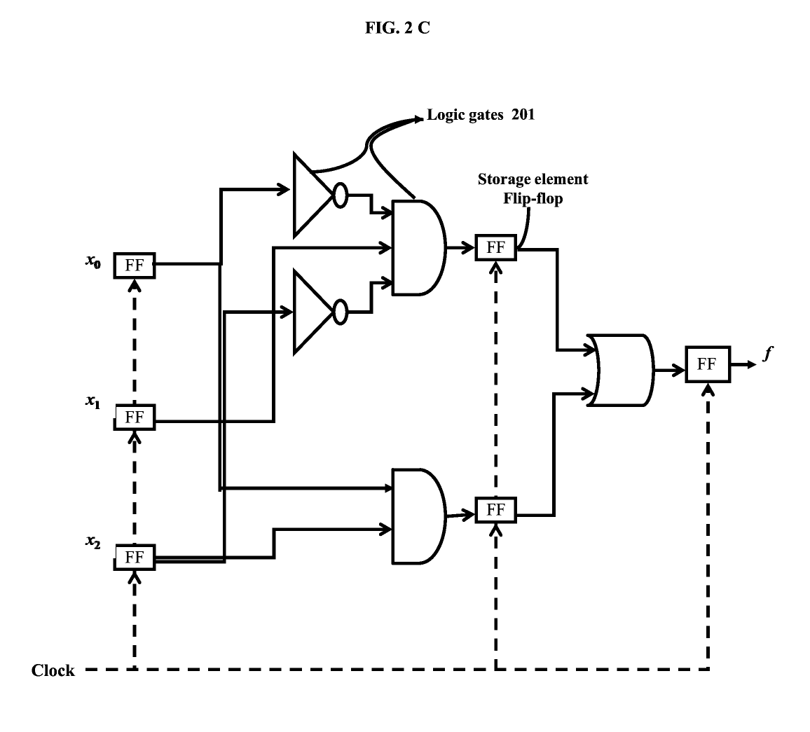

FIGS. 2A, 2B and 2C illustrate an example of Truth Table (TT) based implementation of the logic function, as disclosed in the embodiments herein. A signature set can be expressed in the form of a Truth Table (TT) as depicted in FIG. 2A, such that each n-gram signature derived from a pattern forms a unique row in the TT. For each such row derived from a pattern, an output of ‘1’ is marked in corresponding output column. Note that a TT composed of n-gram (n-bit) signatures has 2ⁿ possible rows. For rows of the TT that do not correspond to a signature, a ‘0’ is entered in the output column. Alternatively, rows of the TT corresponding to signatures, may have a ‘0’ entered in the output column, while rows that do not correspond to signatures have a ‘1’ entered in the output column. In this case, the final output is inverted to produce a hit/miss signal. Whether the first type of TT is used or its alternative is used, depends on which implementation requires less area and power or gives better performance. Note also that a signature may contain don't-care bits (denoted by ‘x’) among its n bits (in addition to “care” bits with values 0 or 1). A bit with an ‘x’ (a don't care bit) indicates that that bit does not contribute any information to the logic function. Having don't care bits in a TT helps to reduce complexity and power consumption and improve performance of the resulting logic function. The TT can be then used to implement a pipelined logic function using Boolean logic gates 201. In this process, the TT values have to be represented using any of the suitable formats such as Boolean equation, Binary Decision Diagram (BDD), Zero suppressed BDD (ZBDD) and so on.

For example, consider a TT which is for a set S of 3-bit signatures, S={010, 101, 111}. The values in the TT can be expressed in a Sum of Product (SOP) as

f= x̅₀̅x₁ x̅₂̅+x₀ x̅₁̅x₂+x₀x₁x₂ (1)

The representation in equation (1) can be factorized and represented as

f= x̅₀̅x₁ x̅₂̅+x₀x₂ (2)

This logic content processing function may be then implemented using logic gates 201 as in FIG. 2B. Further, to this circuit, storage elements may be added to satisfy timing constraints. The storage elements used in this example are Flip-Flops (FF). The circuit with storage elements inserted is depicted in FIG. 2C. Further, the addition of the storage elements i.e. FF here requires use of a synchronization clock, as depicted in FIG. 2C.

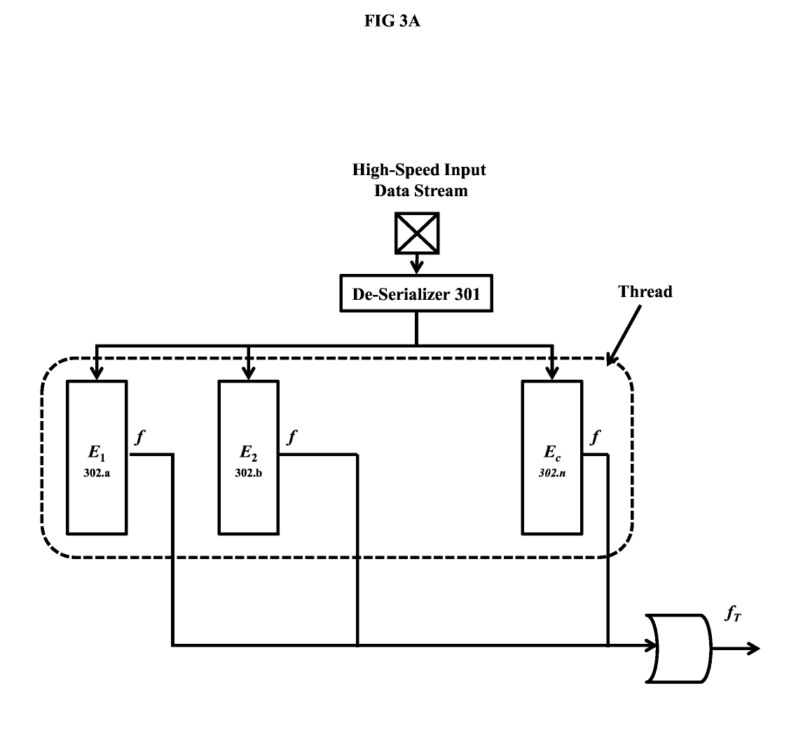

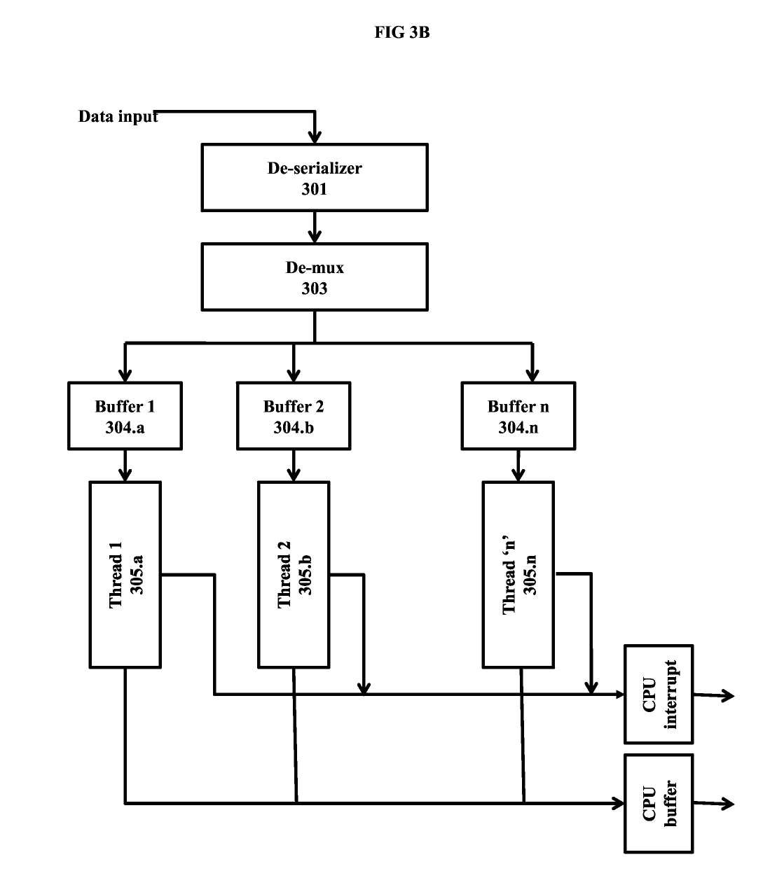

FIGS. 3A and 3B illustrate pattern set scaling and data rate scaling respectively, as disclosed in the embodiments herein. With increase in data stream rates, bandwidth of the MPS system needs to be increased so as to handle incoming traffic. But the logic gates 201 and other internal circuit components have certain limit on the amount of data they can process at a time.

The system achieves scalability by parallelizing along two dimensions namely pattern set and data rate. In order to process a large pattern set, it is divided into smaller subsets such that each subset has a corresponding signature subset, which in turn, has a corresponding logic content processing module that checks for that subset of signatures in an incoming data-stream or file. The collection of the logic content processing modules corresponding to all the pattern subsets acts as one logic content processing module for the whole pattern set and is called a thread. This achieves pattern set scaling using the circuitry as depicted in FIG. 3A. For example, assume that size of the pattern set is ‘K’. Then, the pattern set is divided into ‘c’ subsets of ‘k’ patterns each, where c=ceiling(K/k). Now, the parallel MPS architecture comprises a plurality of distinct LCP modules (Ei) 302, each synthesized to process a specific subset of the pattern set. Output of all the ‘c’ modules together may be considered to process the complete pattern set, and is termed a thread. The input is distributed to all the c modules in parallel and the output of all the modules are logically OR-ed to get the thread level output (f_{T}). The output may be a 0 or a 1, indicating a miss (or mismatch) or a hit (or match) respectively.

Now, assume that each thread can run at a rate of ‘r’ Giga bits per second (Gbps). In order to achieve the overall rate of R Gbps, each thread is to be replicated “d” times, where d=ceiling(R/r). The incoming data-stream or file that comes in at R Gbps, can be slowed down for each of the “d” threads, using the de-multiplexor (also known as de-mux) 303 associated with the data rate scaling architecture depicted in FIG. 3B. The Buffer 304 is capable of receiving and storing bits from the input data stream at the rate of ‘R’ Gbps. Further, in order to ensure that 2 consecutive windows of bits are sent to different replicas, the de-serializer 301 and the de-mux 303 have to possess switching speed of ‘R’ Gbps. The buffer 304 is used to store bits that are coming from an incoming data stream, which enters at a speed of say; R Gb/s. The buffers 304 may get filled with contents of the incoming data stream in a round-robin fashion. Further, each buffer 304 may get filled with “m” number of bits, where m≧n (n=width of each signature and also the number of input bits of each LCP module). The hit-miss signals from the different thread instances are logically OR-ed to generate a ‘hit’ function that is a 1 when one or more threads have a hit. The ‘hit’ output can be sent to a higher level controller for post-processing of the input data-stream for further analysis. In an embodiment, the number of thread instances may be increased or decreased i.e. scaled according to the incoming data rate. As increased number of modules may increase system overhead, the number of modules is chosen accordingly.

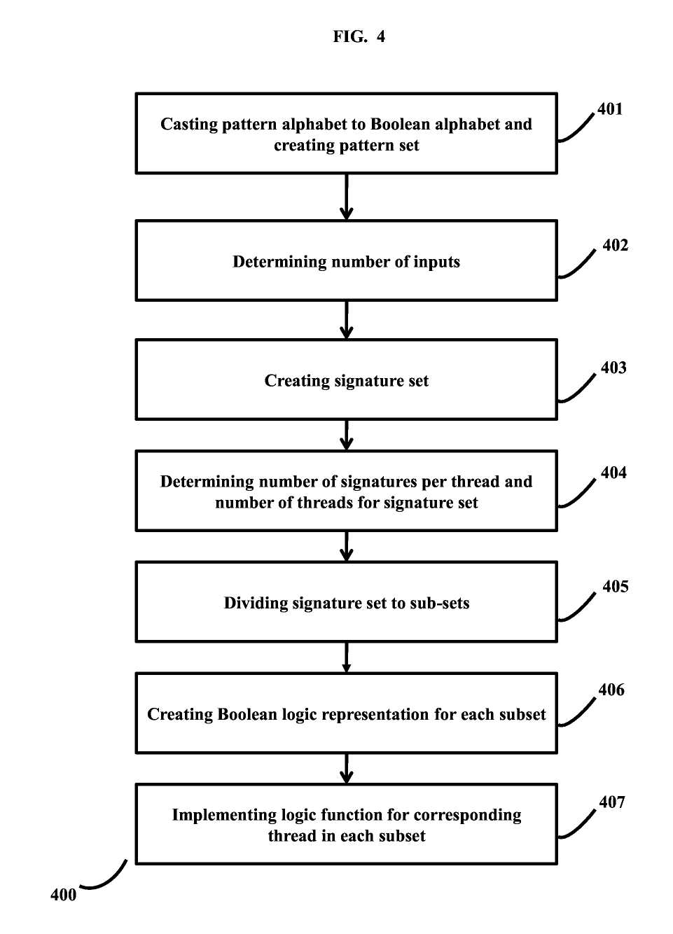

FIG. 4 illustrates a flow diagram that shows various steps involved in the process of generating a logic content based multi pattern search module, as disclosed in the embodiments herein. First step in the logic content based multi pattern search module; hereinafter referred to as LCP module is converting an input pattern set to a machine readable format, for example, a Boolean format. This is achieved through a process called type casting/casting (401). Type-casting is done by mapping every element in the input alphabet to a corresponding unique Boolean vector. For example, consider an alphabet “A” which is a set of all 26 English characters. When type casting, each character is represented using 5 bits. So Boolean alphabet corresponding to “A” will comprise 26 5-bit entries.

Further, number of input bits (n) is calculated (402). In this process, number of input bits for each thread of the LCP module has to be calculated. The number of input bits for each thread of the LCP module is calculated considering 2 factors 1) desired upper bound on probability of false positives (PoFP) and 2) area overhead (AO) as a function of “n”. In various embodiments, value of “n” may be decided based on only PoFP or based on both PoFP and AO as well as other factors. Since the AO can also be controlled using the number of signatures processed by a single thread, AO alone doesn't have to be considered as a parameter to decide value of “n”.

For example for a PoFP upper bound value “p”, and pattern set size of K, value of ‘n’ may be calculated as

n=ceiling(log₂(K/p)) (3)

Further, a signature set where each signature is n-bits long is created (403). The signature set may be created by choosing one or more sub-strings of ‘n’ consecutive bits in each pattern. Further, maximum number of signatures per thread is calculated (404) i.e. number of signatures (J) that can be handled simultaneously using same logic function is calculated. The value of T can be different for different signature subsets. ‘J’ depends on at least 2 factors.

1) The number of logic gates needed to create an LCP function for J n-bit signatures.

2) The capacity and utilization of each programmable logic unit.

Further, if the value T is the same for all signature subsets, knowing the values of ‘J’ and total number of signatures ‘K’, total number of parallel threads required for the signature (T) can be calculated as:

T=ceiling(K/J) (2)

Separate logic functions are defined for each of the T threads. Empirical data maintained in an associated database may also be considered to calculate values of n, J and T. Further, the set of ‘K’ signatures is divided (405) into ‘T’ subsets. In various embodiments, the signatures may be partitioned following any specific format or randomly.

In the next step, Boolean logic function representation is created (406) for each of the ‘T’ subsets. In an embodiment, a signature set may be represented as a Boolean logic function in the form of a Truth Table (TT). The TT can have 2ⁿ n-bit rows, one row per min-term. In the TT corresponding to a signature subset with T signatures, T of these min-terms correspond to T signatures in the signature sub-set. If a single LCP module is used for all K signatures then K of these min-terms correspond to K signatures in the signature set. In one embodiment, a signature may have don't care bits (denoted by x) where the specific bits can take values 0 or 1 or x. Further, output value of min-terms corresponding to signatures is “1” and “0” for non-signature min-terms. Alternatively, the output value of min-terms corresponding to signatures is “0” and “1” for non-signature min-terms, with the final output inverted in order to signal a “1” for a hit and a “0” for a miss. Whether the first option or the alternative is used depends on which representation results in lower area or power or higher performance or fulfills a combination of these and other criteria of the logic content processing module.

In another embodiment, the signature set may be represented as a Boolean logic function by means of Sum-of-Products (SOP) or conjunctive normal form (CNF) that is equivalent to the above TT. In various other embodiments, the signature set may be represented as a Boolean logic function by means of Product-of-Sum (POS), Binary Decision Diagram (BDD), Zero-Suppressed BDD (ZBDD) and so on, each representing an equivalent function as represented by the above TT.

Further, LCP function is implemented (407) for each thread. In this step, the Boolean function is taken as input to a logic synthesis process and a gate level equivalent to the Boolean function is generated automatically using logic synthesis tools. The gate level equivalent is then partitioned into one or more pipeline stages so as to satisfy delay (or speed) constraints. This pipelined logic is then mapped to a target programmable logic. If the gate count along with the placement and routing of the LCP is not feasible in target programmable logic, then the signature set is broken into smaller signature subsets and LCP threads.

The signature subsets may be then searched for in successive n-bit windows of an input data stream using the logic generated as described above. If any of the n-bit windows matches any of the signatures in any of the signature subsets, the corresponding LCP modules produce a “1” to indicate a hit. Since the outputs of all LCP modules in a thread are logically “OR”-ed, the corresponding Threads produce a “1” and in this manner the system produces a “1” at its output thus indicating a “hit”. Or else, a “miss” indicated by the output being “0” is returned. In a preferred embodiment, when a “hit” is returned, the system runs post-processing checks to determine whether the hit corresponds to a pattern of interest or not, so as to eliminate possibility of false positives. In another embodiment, the system allows flexibility in terms of scalability, as logic gates 201 may be added or removed based on input data rate. The various actions in method 400 may be performed in the order presented, in a different order or simultaneously. Further, in some embodiments, some actions listed in FIG. 4 may be omitted.

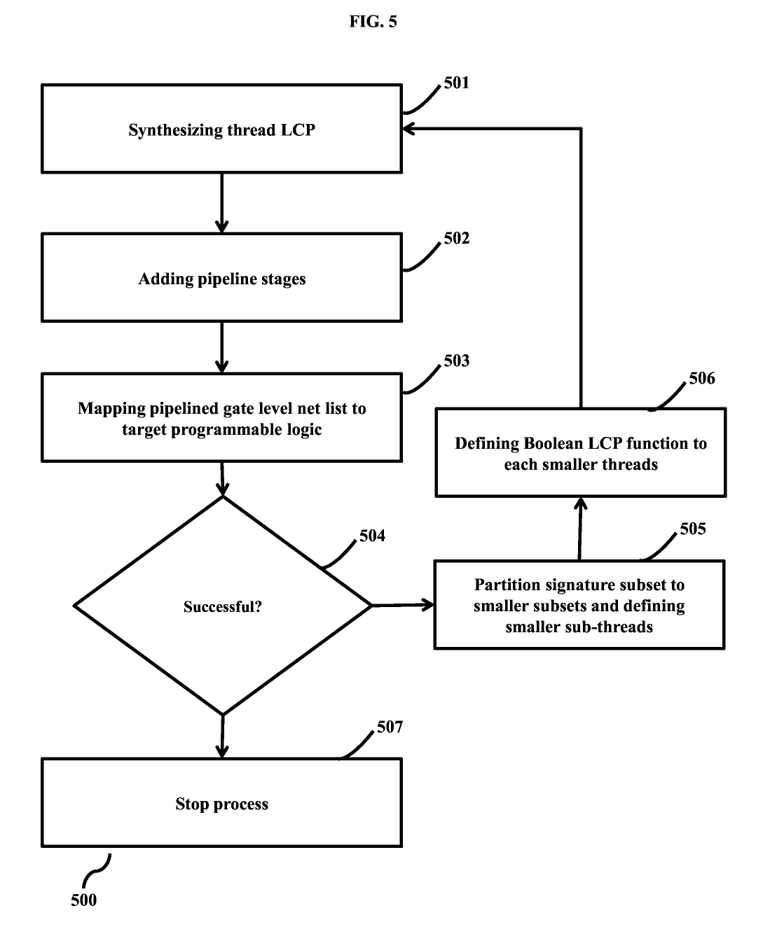

FIG. 5 illustrates a flow diagram that show various steps involved in the process of implementing logic function for each thread required to generate the logic content based multi pattern search module, as disclosed in the embodiments herein. Input to this process is one subset of n-grams comprising a signature subset. Initially, the LCP module corresponding to the input signature subset is synthesized (501) using a cell library of target programmable logic. Any of the suitable logic synthesis tools may be used to synthesize the thread LCP. In the synthesis process, a gate level equivalent of the input LCP function is generated. The gate level netlist may not meet required timing constraints.

Further, pipeline stages consisting of storage elements and a clock are added (502) based on the delay constraints. The pipeline stage identifies “cuts” in the gate level netlist such that the cumulative gate delays between cuts are lower than the given delay constraints and the number of cuts is minimal. In a preferred embodiment, a cut also corresponds to the location where a pipeline register is added, minimizing cuts results in minimizing area overhead.

Further, the pipelined gate level netlist is mapped (503) using a target programmable logic (TPL). If the TPL is an FPGA, a suitable synthesis tool may be used. If the mapping is successful, then the process is ended (507). If the mapping is unsuccessful, i.e. if the LCP thread requires more logic gates 201 than can be accommodated in the target programmable logic, then the system partitions (505) the signature set to smaller subsets and defines smaller LCP modules corresponding to the smaller signature subsets. Further, Boolean LCP function is defined (506) for each of the newly created subsets and synthesis, timing and mapping are repeated for each of the subsets. The various actions in method 500 may be performed in the order presented, in a different order or simultaneously. Further, in some embodiments, some actions listed in FIG. 5 may be omitted.

During normal operation of the system, the input pattern set or the desired upper bound on probability of false positives or desired hardware requirements or data rate may change. Changes to the pattern set include enhancement of the original pattern set by addition of new patterns to the set or removal of existing patterns from the set or modification of existing patterns in the set or a combination of one or more of these actions. Changes to desired upper bound on probability of false positives and desired hardware requirements and data-rate may be expressed as new numbers corresponding to these parameters. When one or more of these inputs change, upon prompting by a controller, which can be one or more of human users, programs or controller devices or a combination of these, the new inputs comprising of the new pattern set or the new upper bound on probability of false positives or the new bound on hardware overhead or new data-rate or a combination of these is re-processed by repeating the steps used to process the original inputs to derive new values of n, the number of bits in each signature, a new signature set corresponding to the new patterns and the new value n, new signature subsets corresponding to the new signature set and the new bounds on hardware requirements, new logic content processing modules corresponding to the new signature subsets, new threads consisting of the new logic content processing modules and a new system consisting of multiple new threads to satisfy the new data rate. In specific cases of these above described changes, one or more of the changes may not be needed and may be omitted.

The embodiments disclosed herein can be implemented through at least one software program running on at least one hardware device and performing network management functions to control the network elements. The network elements shown in FIG. 2 include blocks which can be at least one of a hardware device, or a combination of hardware devices and software module.

The embodiment disclosed herein specifies a system for logic content processing based multi-pattern search or multi-pattern matching. The mechanism allows logic content processing based multi-pattern search, providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. C or C++ along with a hardware description program written in e.g. Verilog or Very high speed integrated circuit Hardware Description Language (VHDL) or another hardware description language, or implemented by one or more of Verilog, VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for performing logic content based multi pattern search for patterns from an input pattern set, said method further comprises:
creating a plurality of signature subsets corresponding to said input pattern set;
representing each of said plurality of signature subsets in the form of corresponding Boolean functions;
implementing each of said Boolean functions as a logic content processing module;
comparing each of said plurality of signature subsets with a plurality of windows of an input data stream or file by said logic content processing module;
returning a hit on a signature of said signature subset being equal to content of at least one of said plurality of windows by said logic content processing module; and
returning a miss on signatures of said signature subset being not equal to content of any one of said plurality of windows by said logic content processing module.

2. The method as in claim 1, wherein said creation of signature subsets further comprises:
mapping each element in said input pattern set to corresponding Boolean alphabet by said logic content processing module;
calculating number of input bits (n) for said logic content processing module;
creating a signature set corresponding to said input pattern set by said logic content processing module; and
calculating maximum number of signatures per subset of said input pattern set.

3. The method as in claim 2, wherein said method further comprises of satisfying a desired upper bound on probability of false positives value and an area overhead value with said number of bits (n) value.

4. The method as in claim 1, wherein said representing each of said plurality of signature subsets in the form of corresponding Boolean function further comprises:
expressing each of said plurality of signature subsets as a truth table;
creating at least one intermediate representation for truth table representation of each subset; and
converting each of said intermediate representation to corresponding Boolean logic function representation.

5. The method as in claim 4, wherein the method further comprises of implementing at least one pipeline stage when the delay through implementation of said logic content processing module is larger than a threshold that is determined by a data-rate.

6. The method as in claim 1, wherein a multi-level scaling is used to improve performance of said logic content based search.

7. The method as in claim 6, wherein said multi-level scaling further comprises pattern set scaling and data rate scaling.

8. The method as in claim 7, wherein said data rate scaling further comprises splitting an input data stream into a plurality of sub-data streams, wherein each of said sub-data stream is an input to a thread.

9. The method, as claimed in claim 1, wherein said thread comprises of a plurality of said Boolean functions corresponding to a complete signature set, where each of said Boolean function corresponds to one signature subset.

10. A computer program product for enabling logic content based multi pattern search, the product comprising:
an integrated circuit comprising at least one processor;
at least one memory having a computer program code within said circuit, wherein said at least one memory and said computer program code with said at least one processor cause said product to:
create a plurality of signature subsets corresponding to said input pattern set;
represent each of said plurality of signature subsets in the form of corresponding Boolean functions;
implement each of said Boolean functions as a logic content processing module;
compare each of said plurality of signature subsets with a plurality of windows of an input data stream or file by said logic content processing module;
return a hit on a signature of said signature subset being equal to content of at least one of said plurality of windows by said logic content processing module; and
return a miss on signatures of said signature subset being not equal to content of any one of said plurality of windows by said logic content processing module.

11. The computer program product, as claimed in claim 10, wherein said at least one processor further causes said product to map each element in said input pattern set to corresponding Boolean alphabet;
calculate number of input bits (n) for said logic content processing module; and
create a signature set corresponding to said input pattern set;
calculate maximum number of signatures per subset of said input pattern set.

12. The computer program product, as claimed in claim 11, wherein said at least one processor further causes said product to satisfy values of a desired upper bound on probability of false positives and an area overhead with said number of input bits (n) of said logic content processing module.

13. The computer program product, as claimed in claim 10, wherein said at least one processor further causes said product to represent each of said plurality of signature subsets in the form of corresponding Boolean function further by:
expressing each of said plurality of signature subsets as a truth table;
creating at least one intermediate representations for truth table representation of each subset; and
converting each of said intermediate representation to corresponding Boolean logic function representation.

14. The computer program product, as claimed in claim 10, wherein said at least one processor further causes said product to implement at least one pipeline stage when the delay through implementation of said logic content processing module is larger than a threshold that is determined by a data-rate.

15. The computer program product, as claimed in claim 10, wherein said at least one processor further causes said product to use at least one of a pattern set scaling and a data rate scaling in said logic content based search.

16. The computer program product, as claimed in claim 15, wherein said at least one processor further causes said product to perform said data rate scaling by splitting an input data stream into a plurality of sub-data streams, wherein each of said sub-data stream is an input to a thread.

17. A computer program product for enabling logic content based multi pattern search, the product comprising:
an integrated circuit comprising at least one processor;
at least one memory having a computer program code within said circuit, wherein said at least one memory and said computer program code with said at least one processor cause said product to:
create a plurality of signature subsets corresponding to said input pattern set;
represent each of said plurality of signature subsets in the form of corresponding Boolean functions; and
implement each of said Boolean functions as a logic content processing module.

18. The computer program product, as claimed in claim 17, wherein said at least one processor further causes said product to map each element in said input pattern set to corresponding Boolean alphabet;
calculate number of input bits (n) for said logic content processing module; and
create a signature set corresponding to said input pattern set;
calculate maximum number of signatures per subset of said input pattern set.

19. The computer program product, as claimed in claim 17, wherein said at least one processor further causes said product to represent each of said plurality of signature subsets in the form of corresponding Boolean function by:
expressing each of said plurality of signature subsets as a truth table;
creating at least one intermediate representations for truth table representation of each subset; and
converting each of said intermediate representation to corresponding Boolean logic function representation.

20. The computer program product, as claimed in claim 17, wherein said at least one processor further causes said product to implement at least one pipeline stage when the delay through implementation of said logic content processing module is larger than a threshold that is determined by a data-rate.

21. A computer program product for enabling logic content based multi pattern search using a logic content processing module, the product comprising:
an integrated circuit comprising at least one processor;
at least one memory having a computer program code within said circuit, wherein said at least one memory and said computer program code with said at least one processor cause said product to:
compare each of a plurality of signature subsets with a plurality of windows of an input data stream or file, wherein said plurality of signature subsets correspond to an input pattern set and said logic content processing module is an implementation of Boolean functions, wherein each Boolean function is a representation of one of said plurality of signature subsets;
return a hit on a signature of said signature subset being equal to content of at least one of said plurality of windows; and
return a miss on signatures of said signature subset being not equal to content of any one of said plurality of windows.

22. The computer program product, as claimed in claim 21, wherein said at least one processor further causes said product to implement at least one pipeline stage when the delay through implementation of said logic content processing module is larger than a threshold that is determined by a data-rate.

23. The computer program product, as claimed in claim 21, wherein said at least one processor further causes said product to use at least one of a pattern set scaling and a data rate scaling in said logic content based search.

24. The computer program product, as claimed in claim 23, wherein said at least one processor further causes said product to perform said data rate scaling by splitting an input data stream into a plurality of sub-data streams, wherein each of said sub-data stream is an input to a thread.
